(19) United States
(12) Patent Application Publication
(10) Pub. No.: US 2026/0106352 A1
(43) Pub. Date: Apr. 16, 2026

(54) BATTERY CELL COMPRISING CURRENT BREAKER AND BATTERY APPARATUS COMPRISING SAME

(71) Applicant: SK ON CO., LTD., Seoul (KR)

(72) Inventors: Sin-Young MOON, Daejeon (KR); Dong-Hee KIM, Daejeon (KR); Jeong-Hun SHIN, Daejeon (KR); Bo-Ra JEONG, Daejeon (KR)

(21) Appl. No.: 19/116,323

(22) PCT Filed: Jun. 9, 2023
(86) PCT No.: PCT/KR2023/007976

§ 371 Date: Mar. 27, 2025

(30) Foreign Application Priority Data
Nov. 14, 2022 (KR) 10-2022-0151607

(51) Int. Cl. H01M 50/581; H01M 50/178; H01M 50/211; H01M 50/502; H01M 50/531; H01M 50/553; H01M 50/562; H01M 50/583

(52) U.S. Cl. CPC H01M 50/581; H01M 50/178; H01M 50/211; H01M 50/502; H01M 50/531; H01M 50/553; H01M 50/562; H01M 50/583; H01M 2200/103

(57) ABSTRACT

A battery cell according to an embodiment of the present invention comprises: an electrode assembly on which at least one positive electrode plate and at least one negative electrode plate are stacked on each other; a case for accommodating the electrode assembly therein; a plurality of electrode tabs extending from the positive electrode plate and the negative electrode plate; an electrode lead one end of which is joined with the electrode tabs and the other end of which is exposed to the outside of the case; and a current breaker which is arranged inside the electrode lead and breaks the flow of an overcurrent, wherein the length of the current breaker according to the extension direction of the electrode lead can be formed to be at most 1/10 of the length of the electrode lead.

### TECHNICAL FIELD

The present disclosure relates to a battery cell including a current breaking portion and a battery device having the same.

### BACKGROUND ART

Unlike primary batteries, secondary batteries may be charged and discharged, so that secondary batteries may be applied to devices within various fields such as digital cameras, mobile phones, laptops, and hybrid cars. Secondary batteries may include nickel-cadmium batteries, nickel-metal hydride batteries, nickel-hydrogen batteries, lithium secondary batteries, or the like.

Among such secondary batteries, extensive research is being conducted on lithium secondary batteries with high energy density and discharge voltage. Recently, lithium secondary batteries are being used in the form of battery modules or battery packs which connect a plurality of pouch-type battery cells having flexibility. The plurality of battery cells within a module or pack have electrode leads interconnected in series or in parallel. Therefore, if a hazardous situation occurs in one battery cell, there is a possibility that all battery cells which are electrically connected may react in a chain reaction, thereby spreading the hazardous situation.

Therefore, even when an overcurrent occurs due to a short circuit, or the like in one battery cell, a method for preventing the overcurrent from flowing into other battery cells is required.

### SUMMARY OF INVENTION

### Technical Problem

An aspect of the present disclosure is to provide a battery cell for breaking a flow of overcurrent to increase stability and a battery device having the same.

### Solution to Problem

According to an aspect of the present disclosure, provided is a battery cell, the battery cell including: an electrode assembly in which at least one positive electrode plate and at least one negative electrode plate are stacked with each other; a case accommodating the electrode assembly therein; a plurality of electrode tabs respectively extending from the positive electrode plate and the negative electrode plate; an electrode lead having one end bonded to the electrode tab and the other end exposed to the outside of the case; and a current breaking portion disposed inside the electrode lead to break a flow of overcurrent, wherein a length of the current breaking portion in an extension direction of the electrode lead may be formed to be at most 1/10 of a length of the electrode lead.

The current breaking portion may be formed of a material which is melted in a range of 150° C. to 185° C.

The current breaking portion may be formed of a material having an electrical resistivity of 0.2 μΩ·m or less.

The current breaking portion may be formed of a material having a thermal conductivity of 40 W/m K or more.

The current breaking portion may be formed of a material having a tensile strength of 100 kgf/cm² or more.

The current breaking portion may be formed of an alloy material including tin (Sn).

The current breaking portion may be formed of any one material selected from the group consisting of tin/lead, tin/lead/silver, tin/indium/silver, and tin/lead/indium.

The tin/lead may be an alloy comprising 60 to 65 wt % of tin and 35 to 40 wt % of lead, the tin/lead/silver may be an alloy in which 1 to 2 wt % of silver is added to the tin/lead, the tin/indium/silver may be an alloy comprising 75 to 80 wt % of tin, 18 to 22 wt % of indium, and 1 to 5 wt % of silver, and the tin/lead/indium may be an alloy comprising 68 to 72 wt % of tin, 15 to 20 wt % of lead, and 10 to 15 wt % of indium.

The current breaking portion may be formed of any one material selected from the group consisting of Sn63/Pb37, Sn62.5/Pb36.1/Ag1.4, Sn60/Pb40, Sn77.2/In20/Ag2.8, and Sn70/Pb18/In12.

The electrode lead may include a first lead disposed between the current breaking portion and the electrode tab and a second lead disposed on the opposite side of the first lead.

The electrode lead may be a negative electrode lead connected to the negative electrode plate.

The electrode lead may be formed of a copper (Cu) material.

According to an aspect of the present disclosure, provided is a battery cell, the battery cell including: an electrode assembly in which at least one positive electrode plate and at least one negative electrode plate are stacked with each other; a case accommodating the electrode assembly therein; a plurality of electrode tabs respectively extending from the positive electrode plate and the negative electrode plate; an electrode lead having one end bonded to the electrode tab and the other end extending to the outside of the case; and a current breaking portion disposed inside the electrode lead to break a flow of overcurrent, wherein the current breaking portion may be formed of a material which is melted in a range of 150° C. to 185° C., has an electrical resistivity of 0.2 μΩ·m or less, and has a tensile strength of 100 kgf/cm² or more.

According to an aspect of the present disclosure, provided is a battery apparatus, the battery apparatus including: a plurality of battery cells having a case in which an electrode assembly is accommodated and an electrode lead extending from the electrode assembly and at least a portion of which is disposed outside the case; and a bus bar coupled to the electrode lead, wherein a current breaking portion to break a flow of overcurrent is disposed inside the electrode lead, and the current breaking portion is disposed to be spaced apart from the bus bar by a certain distance.

The current breaking portion may be formed of a material which is melted in a range of 150° C. to 185° C.

### Advantageous Effects of Invention

As set forth above, since a battery cell according to an embodiment of the present disclosure includes a current breaking portion in an electrode lead, even if abnormal phenomena such as high heat, overcurrent, or the like, occur in the battery cell, a flow of current may be rapidly broken. Therefore, it is possible to prevent abnormal phenomena from spreading to other battery cells or affecting the battery apparatus.

### BRIEF DESCRIPTION OF DRAWINGS

FIG. 1 is a perspective view schematically illustrating a battery cell according to an embodiment of the present disclosure.

FIG. 2 is an exploded perspective view of FIG. 1.

FIG. 3 is a cross-sectional view taken along line I-I′ of FIG. 1.

FIG. 4 is a perspective view schematically illustrating a battery device including the battery cell of FIG. 1.

FIG. 5 is an exploded perspective view of FIG. 4.

FIG. 6 is a cross-sectional view taken along line II-II′ of FIG. 4.

### MODE FOR INVENTION

Prior to the detailed description of the present disclosure, the terms or words used in the present specification and claims described below should not be construed as being limited to common or dictionary meanings, and the inventor intends to use his/her invention in the best way. Based on the principle that terms may be properly defined for description, they should be interpreted as having meanings and concepts consistent with the technical spirit of the present disclosure. Therefore, the embodiments described in this specification and the configurations shown in the drawings are only the most preferred embodiments of the present disclosure, and do not represent all of the technical spirit of the present disclosure, so it should be understood that there may be various equivalents and modifications that can be substituted therefor at the time of this application.

Hereinafter, preferred embodiments of the present disclosure will be described in detail with reference to the attached drawings. In this case, it should be noted that in the attached drawings, the same components are indicated by the same reference symbols whenever possible. In addition, detailed descriptions of functions and configurations known in the art that may obscure the gist of the present disclosure will be omitted. For the same reason, in the accompanying drawings, some components are exaggerated, omitted, or schematically shown, and the size of each component does not entirely reflect the actual size.

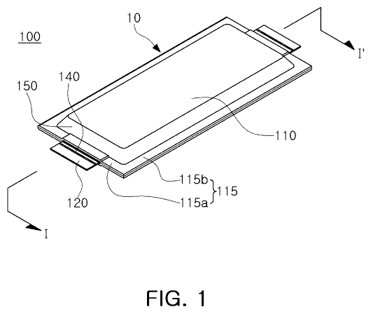

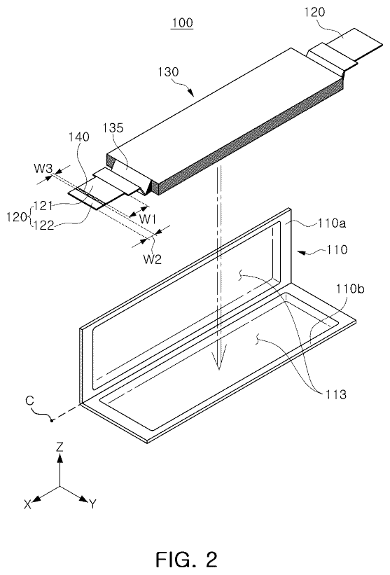

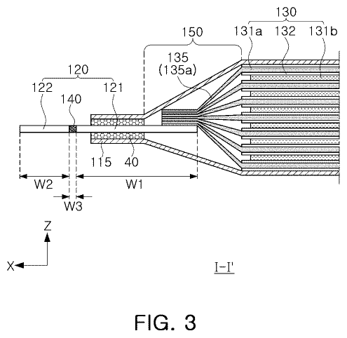

FIG. 1 is a perspective view schematically illustrating a battery cell according to an embodiment of the present disclosure, FIG. 2 is an exploded perspective view of the battery cell illustrated in FIG. 1, and FIG. 3 is a cross-sectional view taken along line I-I′ of FIG. 1.

Referring to FIGS. 1 to 3, a battery cell 100 according to the present embodiment may include an electrode assembly 130, a case 110 accommodating the electrode assembly, and a protective film 40.

The battery cell 100 according to the present embodiment is a rechargeable secondary battery, and may include a lithium ion (Li-ion) battery or a nickel metal hydride (Ni-MH) battery. The nickel metal hydride battery is a secondary battery using nickel as a positive electrode, a hydrogen storage alloy as a negative electrode, and an alkaline aqueous solution as an electrolyte. Since the nickel metal hydride battery has a high capacity per unit volume, the nickel metal hydride battery may be used as an energy source for electric vehicles (EVs) and hybrid vehicles (HEVs), and may also be used in various fields such as energy storage.

The battery cell 100 may have a pouch-type structure. The case 110 may be used by insulating a surface of a metal layer formed of, for example, aluminum. Insulation may performed by applying modified polypropylene, a polymer resin, to the surface of the metal layer and stacking a resin material such as nylon or polyethylene terephthalate (PET) on an outer surface thereof.

The case 110 may be provided with an accommodating space 113 in which an electrode assembly 130 is accommodated therein. An electrode lead 120 may be disposed to protrude to the outside of the case 110.

As illustrated in FIG. 2, the battery cell 100 of the present embodiment may seal the accommodating space 113 by folding a single sheet of outer material and then bonding three side surfaces thereof. Accordingly, the case 110 of the present embodiment may be divided into a first case 110a and a second case 110b based on a fold line (C) at which the outer material is folded.

Specifically, the battery cell 100 of the present embodiment may be manufactured by accommodating an electrode assembly 130 in an accommodating space 113, folding an outer material in a fold line (C), and then bonding an edge in which the first case 110a and the second case 110b meet to seal the accommodating space 113.

As a method of joining the edge, a thermal fusion method may be used, but the present disclosure is not limited thereto. Hereinafter, the bonded edge portion is referred to as a sealing portion 115.

In the present embodiment, the sealing portion 115 may be divided into a first sealing portion 115a formed in a portion in which an electrode lead 120 is disposed, and a second sealing portion 115b formed in a portion in which the electrode lead 120 is not disposed.

The sealing portion 115 may be formed in the form of a flange extending outwardly from the accommodating space 113 described above. Accordingly, the sealing portion 115 may be disposed along the outer periphery of the accommodating space 113.

Meanwhile, in the present embodiment, a case in which a battery cell is manufactured by folding an outer material is illustrated as an example, but the present disclosure is not limited thereto, and the first case 110a and the second case 110b may be formed using separate outer materials, respectively. In this case, a sealing portion 115 may be disposed on all four side surfaces of the accommodating portion 113.

In addition, the battery cell 110 of the present embodiment may be provided with an accommodating space 113 in each of the first case 110a and the second case 110b. However, the configuration of the present disclosure is not limited thereto, and various modifications are possible, such as providing the accommodating space 113 in only one of the first case 110a and the second case 110b.

The electrode assembly 130 may be accommodated together with an electrolyte in the accommodating space 113 inside the case 110. The electrode assembly 130 may include a plurality of electrodes 131a and 131b divided into a positive electrode plate 131a and a negative electrode plate 131b, and a separator 132 disposed between the positive electrode plate 131a and the negative electrode plate 131a to electrically/physically separate the positive electrode plate 131a and the negative plate 131b.

The electrodes 131a and 131b may be formed by applying a positive electrode active material or a negative electrode active material to one or both sides of a metal thin film. In addition, the electrode assembly 130 may be provided in a form in which a plurality of positive electrode plates 131a and a plurality of negative electrode plates 131b are alternately stacked.

An electrode tab 135 may be between the electrode assembly 130 and the sealing portion 115. The electrode tab 135 may include a positive electrode tab 135a extending from a positive electrode plate 131a and a negative electrode tab 135b extending from a negative electrode plate 131b.

The electrode tab 135 may be accommodated in a terrace (150 in FIG. 3). In the present embodiment, the terrace 150 may correspond to the periphery of a portion of the case 110 accommodating the electrode assembly 130. In addition, the terrace 150 may be defined as a portion corresponding to the electrode assembly 130 and the sealing portion 115 among the cases 110.

In the present embodiment, the electrode tab 135 is drawn out toward a first sealing portion 115a. A terrace 150 of the present embodiment may include a region between the electrode assembly 130 and the first sealing portion 115a.

However, even if the electrode tab 135 is not accommodated, free space formed between the electrode assembly 130 and the sealing portion 115 or a portion which is not pressed (or contacted) between the battery cells 100 when battery cells are stacked may be included in the terrace 150. For example, the terrace 150 may include a section in which a thickness of the battery cell 100 gradually decreases toward the sealing portion 115.

The electrode lead 120 may electrically connect the battery cell 100 to another external device. One end of the electrode lead 120 may be bonded to the electrode tab 135 to be electrically connected to the electrode assembly 130, and the other end of the electrode lead 120 may extend in an X-axis direction and be exposed to the outside of the case 110.

The electrode lead 120 may include a positive electrode lead 120a connected to a positive electrode tab 135a and a negative electrode lead 120b connected to a negative electrode tab 135b.

The positive electrode lead 120a and the negative electrode lead 120b may be formed of a thin plate-shaped metal. For example, the positive electrode lead 120a may be formed of an aluminum (Al) material, and the negative electrode lead 120b may be formed of a copper (Cu) material. However, the present disclosure is not limited thereto.

In the present embodiment, the positive electrode lead 120a and the negative electrode lead 120b are disposed to be in opposite directions, and thus the positive electrode lead 120a and the negative electrode lead 120b are disposed to protrude from both side surfaces of the case 110. However, the configuration of the present disclosure is not limited thereto, and various modifications are possible as needed, such as disposing the positive electrode lead 120a and the negative electrode lead 120b to be in the same direction.

In a battery cell 100 configured in this manner, abnormal situations such as swelling, electrode short circuit, overcharge, overdischarge, overheating, surge current, overcurrent, electrode short circuit, or the like during operation, and in this case, which may lead to an explosion or fire accident of the battery cell 100.

Therefore, to prevent the above-described problems, the battery cell 100 of the present embodiment may be provided with at least one current breaking portion 140.

When the abnormal phenomena described above occur and a temperature of the battery cell 100 increases, the current breaking portion 140 may break electrical connection between the battery cell 100 and other battery cells 100.

When the battery cell 100 is operating normally, an internal temperature of the battery cell 100 may increase to close to 120° C. It was confirmed that when the temperature of the battery cell 100 exceeds 190° C., an explosion or flame occurs in the battery cell 100, causing thermal runaway. Therefore, in order to prevent thermal runaway from occurring, it is necessary to break the flow of current between the battery cells 100 before the internal temperature of the battery cell 100 exceeds 190° C.

Accordingly, the battery cell 100 of the present embodiment may break electrical connection between the battery cell 100 and other elements when the internal temperature thereof is within a range of 120° C. or higher and 190° C. or lower. More specifically, the current breaking portion 140 of the present embodiment may break electrical connection with external elements when the internal temperature of the battery cell 100 is in the range of 150° C. to 185° C., considering a deviation in temperature between the electrode assembly 130 and the electrode lead 120, or the like. Accordingly, the current breaking portion 140 may be formed of a material that can be rapidly melted in a temperature range of 150° C. to 185° C.

The current breaking portion 140 may be provided on at least one of the positive electrode lead 120a and the negative electrode lead 120b. Since the negative electrode lead 120b formed of copper (Cu) has higher thermal conductivity than the positive electrode lead 120a formed of aluminum, a temperature change may occur quickly. Therefore, the current breaking portion 140 of the present embodiment is provided on the negative electrode lead 120b to quickly detect the temperature change of the battery cell 100. However, various modifications are possible as needed, such as disposing the current breaking portion 140 on each of the negative electrode lead 120b and the positive electrode lead 120a, or disposing the current breaking portion 140 only on the positive electrode lead 120a.

In addition, the current breaking portion 140 may be disposed in a form intersecting the electrode lead 120. Specifically, the negative electrode lead 120b may be divided into a first lead 121 and a second lead 122, which are separated from each other by the current breaking portion 140, and the first lead 121 and the second lead 122 may be respectively bonded to both sides of the current breaking portion 140. For example, the first lead 121 may be disposed between the current breaking portion 140 and the electrode tab 135, and the second lead 122 may be disposed outside the current breaking portion 140 and be coupled to a bus bar (170 in FIG. 7) to be described later. Therefore, the first lead 121 and the second lead 122 may be electrically/physically connected to each other via the current breaking portion 140, and a separation distance between the first lead 121 and the second lead 122 may be defined by the current breaking portion 140.

The current breaking portion 140 may be formed of a conductive material similar to the electrode lead 120 and may be formed with a thickness which is the same as or similar to the electrode lead 120.

In addition, referring to FIG. 3, a length (or width, W3) of the current breaking portion 140 in the extension direction (X direction) of the electrode lead 120 may be formed to be approximately 1/10 or less of the total length of the electrode lead 120, except for the current breaking portion 140. Here, the total length of the electrode lead 120 may be defined as the sum of a length (W1) of the first lead 121 and a length (W2) of the second lead 122 based on the battery cell. In the present embodiment, the length of the current breaking portion 140 is the configuration derived by considering the electrical resistance of the current breaking portion 140 to be described later.

In addition, if the current breaking portion 140 is formed with a length of less than 0.1 mm, a distance between the first lead 121 and the second lead 122 is too narrow, so even if the current breaking portion 140 melts, there may be a possibility that the first lead 121 and the second lead 122 are electrically connected. Therefore, the current breaking portion 140 of the present embodiment may be formed to have a length of 0.1 mm or more.

For example, when the total length (W1+W2) of the negative electrode lead 120b is 60 mm, a length (W3) of the current breaking portion 140 may be formed to have a thickness of 6 mm or less. Therefore, in this case, the first lead 121 and the second lead 122 may be disposed to be spaced apart by a distance of 6 mm or less. However, the configuration of the present disclosure is not limited thereto.

Since the current breaking portion 140 is disposed inside the negative electrode lead 120b, when the battery cell 100 operates normally, it is used as a path for current to flow, similarly to the negative electrode lead 120b.

To this end, the current breaking portion 140 of the present embodiment can be formed to have an electrical resistance similar to the overall resistance of the negative electrode lead 120b. Specifically, in the present embodiment, the current breaking portion 140 may be formed of a material having an electric resistivity of 10 times or less than that of the electrode lead 120. For example, when the negative electrode lead 120b is formed of a copper material, since the electrical resistivity of copper (Cu) is approximately 0.02 μΩ·m, the resistivity of the current breaking portion 140 may be formed of a material of about 0.2 μΩ·m or less.

As described above, the length (W3) of the current breaking portion 140 of the present embodiment is formed to have approximately 1/10 of the length (W1+W2) of the negative electrode lead 120b, and since the resistance is proportional to the length, if the current breaking portion 140 is formed of a material having an electrical resistivity of approximately 0.2 μΩ·m or less, the overall resistance of the current breaking portion 140 may have a level similar to the overall resistance of the negative electrode lead 120b.

In this case, since the overall resistance of the current breaking portion 140 and the negative electrode lead 120b may be considered to be equivalent to the case in which the length of the negative electrode lead 120b is extended by two times, it can be seen that even if the current breaking portion 140 of the present embodiment is included, the flow of current is not significantly hindered. Therefore, the current breaking portion 140 of the present embodiment may be formed to have) a length of about 1/10 of the length (W1+W2) of the electrode lead 120 in consideration of the smooth flow of current.

In addition, a thermal conductivity of copper (Cu) forming the negative electrode lead 120b is approximately 400 W/m·K. Therefore, it is also advantageous to use a material for the current breaking portion 140 having a thermal conductivity similar to that of the negative electrode lead 120b, but in this case, there is a problem in that a melting point of the current breaking portion 140 increases. Accordingly, in the present embodiment, the current breaking portion 140 is formed of a material having a thermal conductivity lower than that of the negative electrode lead 120b, and having a thermal conductivity of at least 1/10 of the negative electrode lead 120b, that is, a material having a thermal conductivity of 40 W/m K or more.

In this case, the current breaking portion 140 has a lower thermal conductivity than the negative electrode lead 120b, but has a higher electrical resistance than the negative electrode lead 120b. Therefore, for the same flow of current, heat may be generated faster in the current breaking portion 140 than in the negative electrode lead 120. Accordingly, when an overcurrent flows, the current breaking portion 140 may reach a critical temperature more quickly and be melted.

When the thermal conductivity of the current breaking portion 140 is less than 40 W/m K, an error may occur at a point in time at which the current breaking portion 140 is melted due to the low thermal conductivity. That is, the interior of the battery cell 100 may reach a thermal runaway temperature before the current breaking portion 140 is melted.

Therefore, in the present embodiment, the current breaking portion 140 may be formed of a material having a thermal conductivity of 40 W/m K or more.

Meanwhile, in order to maintain the overall shape of the negative electrode lead 120b, it is advantageous for the current breaking portion 140 to have a certain level of rigidity. When the tensile strength is less than 100 kgf/cm², a problem in which the current breaking portion 140 is bent due to the low material rigidity. Accordingly, in the present embodiment, the current breaking portion 140 may be formed of a material having a tensile strength of 100 kgf/cm² or more.

Therefore, the current breaking portion 140 of the present embodiment may be formed of a material having a melting point in the range of 150° C. to 185° C., an electrical resistivity of 0.2 μΩ·m or less, a thermal conductivity of 40 W/m·K or more, and a tensile strength of 100 kgf/cm² or more.

TABLE 1

| | | Melting | Electrical | Thermal | Tensile |
|---|---|---|---|---|---|
| | | point | resistivity | conductivity | strength |
| | Alloy | (° C.) | (μΩ · m) | (W/m · K) | (kgf/cm²) |
| Example 1 | Sn63/Pb37 | 183 | 0.145 | 50 | 525 |
| Example 2 | Sn62.5/Pb36.1/Ag1.4 | 179 | 0.145 | 50 | 490 |
| Example 3 | Sn60/Pb40 | 183 | 0.153 | 49 | 535 |
| Example 4 | Sn77.2/In20/Ag2.8 | 175 | 0.176 | 54 | 480 |
| Example 5 | Sn70/Pb18/In12 | 154 | 0.141 | 45 | 375 |
| Comparative | Sn91/Zn09 | 200 | 0.115 | 61 | 560 |
| Example 1 | | | | | |
| Comparative | Sn10/Pb90 | 275 | 0.194 | 25 | 310 |
| Example 2 | | | | | |
| Comparative | Sn20Pb80 | 183 | 0.198 | 37 | 340 |
| Example 3 | | | | | |
| Comparative | In70Pb30 | 165 | 0.196 | 38 | 245 |
| Example 4 | | | | | |
| Comparative | In60Pb40 | 173 | 0.246 | 29 | 290 |
| Example 5 | | | | | |
| Comparative | In50Pb50 | 184 | 0.287 | 22 | 330 |
| Example 6 | | | | | |
| Comparative | Indium(pure) | 157 | 0.0837 | 86 | 20 |
| Example 7 | | | | | |

Table 1 is a table listing various Examples and Comparative Examples of materials for a current breaking portion according to the present embodiment, and Examples 1 to 5 represent materials meeting all of the conditions described above, and Comparative Examples 1 to 7 represent materials not meeting at least one of the conditions described above. Here, a tensile strength represents a value measured according to ISO 6892-1, an international standard for a tensile test of metal materials.

Referring to Table 1, materials which are suitable for the current breaking portion 140 according to the present embodiment may include Sn63/Pb37, Sn62.5/Pb36.1/Ag1.4, Sn60/Pb40, Sn77.2/In20/Ag2.8, Sn70/Pb18/In12, or the like disclosed in Examples 1 to 5. Here, the numbers represent weight % of the corresponding elements.

Sn63/Pb37, Sn62.5/Pb36.1/Ag1.4, Sn60/Pb40, Sn77.2/In20/Ag2.8, Sn70/Pb18/In12, or the like have melting points in the range of 150° C. to 185° C., and therefore, may be considered as materials for the current breaking portion 140. On the other hand, Sn70/Pb18/In12, Sn91/Zn09, or the like disclosed in Comparative Examples 1 and 2 have melting points of 200° C. or higher, so it is difficult for these materials to be considered as a material suitable for the current breaking portion 140 of the present embodiment.

In addition, Sn63/Pb37, Sn62.5/Pb36.1/Ag1.4, Sn60/Pb40, Sn77.2/In20/Ag2.8, Sn70/Pb18/In12, or the like disclosed in Examples 1 to 5 have an electrical resistivity of 0.2 μΩm or less and a thermal conductivity of about 40 W/m K or more, those disclosed in Comparative Examples 5 and 6 have an electrical resistivity exceeding 0.2 μΩ m, and those disclosed in Comparative Examples 2 to 6 all have thermal conductivity of less than 40 W/m K, so it is difficult for these materials to be considered as a material suitable for the current breaking portion 140 of the present embodiment.

In addition, pure indium of Comparative Example 7 satisfies the above-described conditions in terms of a melting point, electrical resistivity, and thermal conductivity, but since a tensile strength of pure indium is less than 100 kgf/cm², difficult for this material to be considered as a material suitable for the current breaking portion 140 of the present embodiment.

Accordingly, the current breaking portion 140 according to the present embodiment may be formed of any one of the materials Sn63/Pb37, Sn62.5/Pb36.1/Ag1.4, Sn60/Pb40, Sn77.2/In20/Ag2.8, and Sn70/Pb18/In12 disclosed in Examples 1 to 5.

The materials of Examples 1 to 5 may be formed of a low-melting point metal having a melting point lower than that of tin (Sn). Specifically, the current breaking portion 140 may include tin (Sn) as a main element, and may further include at least one element to lower the melting point.

For example, the current breaking portion may additionally include at least one element of lead (Pb), silver (Ag), and indium (In), and specifically, the current breaking portion of the present embodiment may be any one selected from an alloy comprising tin/lead, tin/lead/silver, tin/indium/silver, and tin/lead/indium.

Here, the tin/lead alloy may be an alloy comprising 60 to 65 wt % tin (Sn) and 35 to 40 wt % lead (Pb), and the tin/lead/silver alloy may be an alloy in which 1 to 2 wt % silver (Ag) is added to the tin/lead alloy. In addition, the tin/indium/silver alloy may be an alloy comprising 75 to 80 wt % tin (Sn), 18 to 22 wt % indium (In), and 1 to 5 wt % silver (Ag), and the tin/lead/indium alloy may be an alloy comprising 68 to 72 wt % tin (Sn), 15 to 20 wt % lead (Pb), and 10 to 15 wt % indium (In).

Since the battery cell 100 of the present embodiment described above includes a current breaking portion 140 in the electrode lead 120, even if abnormal phenomena such as high heat, overcurrent, or the like occurs in the battery cell 100, a flow of current may be quickly broken. Therefore, the abnormal phenomena may be prevented from spreading to other battery cells 100 or affecting the battery apparatus.

In addition, the current breaking portion 140 of the present embodiment may be mutually bonded to a first lead 121 and a second lead 122 only by being melted in contact with the first lead 121 and the second lead 122, and then being hardened. Therefore, since the electrode lead 120 is not melted or deformed during the process of bonding the current breaking portion 140 to the electrode lead 120, the electrical resistance in a bonding portion may be minimized.

Meanwhile, the present disclosure is not limited to the above-described embodiments and various modifications are possible.

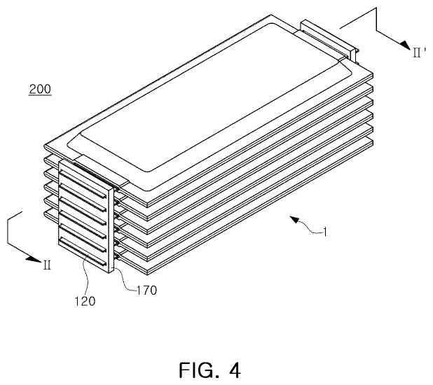

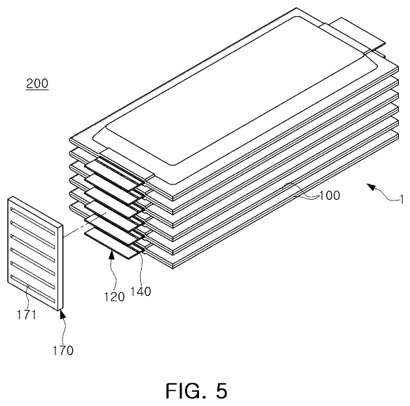

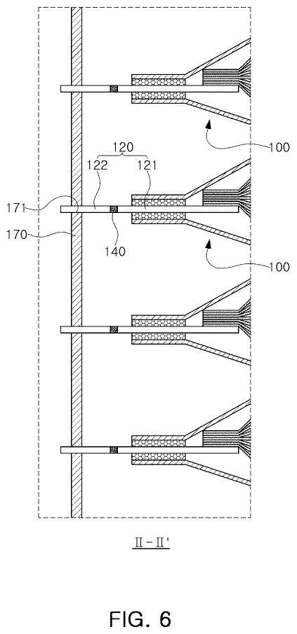

FIG. 4 is a perspective view schematically illustrating a battery apparatus including the battery cell of FIG. 1, FIG. 5 is an exploded perspective view of FIG. 4, and FIG. 6 is a cross-sectional view taken along line II-II′ of FIG. 4.

Referring to FIGS. 4 to 6, a battery apparatus 200 of the present embodiment may include a cell stack 1 in which the plurality of battery cells 100 described above are stacked, and a bus bar 170.

The cell stack 1 may be formed by stacking the plurality of battery cells 100 described above in a thickness direction of the battery cell 100.

The bus bar 170 may be formed in the form of a metal plate and be disposed so as to face one side of the cell stack 1. Here, one side of the cell stack 1 may mean a side surface in which the electrode lead 120 is disposed.

The electrode lead 120 may be coupled to the bus bar 170. Therefore, the battery cells 100 may be electrically connected to each other through the bus bar 170. Accordingly, at least a portion of the end of the electrode lead 120 may completely penetrate through the bus bar 170 and be exposed to the outside of the bus bar 170.

To this end, the bus bar 170 may be provided with a plurality of through-holes 171 into which electrode leads 120 are inserted and disposed, and the electrode leads 120 may be inserted into the through-holes 171 of the bus bar 170 and then bonded to the bus bar 170 by welding, or the like.

In addition, in the battery apparatus 200 of the present embodiment, the current breaking portion 140 may be disposed to be spaced apart from the bus bar 70 by a certain distance. When the current breaking portion 140 is disposed within the through-hole 171, even if the current breaking portion 140 is melted, contact between the electrode lead 120 and the bus bar 170 may be maintained, and in this case, the flow of current may be maintained, which may lead to the above-described abnormal phenomena. Therefore, in the battery apparatus 200 of the present embodiment, the current breaking portion 140 may be spaced apart from the through-hole 171 of the bus bar 170 and disposed outside the through-hole 171.

While exemplary embodiments have been illustrated and described above, it will be apparent to those skilled in the art that modifications and variations could be made without departing from the scope of the present invention as defined by the appended claims.

For example, in the above-described embodiments, a case in which the cooling device is disposed on the outside of the first plate is illustrated as an example, but various modifications are possible, such as a case in which the cooling device is disposed inside the first plate, or the first plate is configured to include a cooling path. In addition, respective embodiments may be performed in combination with each other.

1. A battery cell, comprising:
an electrode assembly in which at least one positive electrode plate and at least one negative electrode plate are stacked with each other;
a case accommodating the electrode assembly therein;
a plurality of electrode tabs respectively extending from the positive electrode plate and the negative electrode plate;
an electrode lead having one end bonded to the electrode tab and the other end extending to the outside of the case; and
a current breaking portion disposed inside the electrode lead to break a flow of overcurrent,
wherein a length of the current breaking portion in an extension direction of the electrode lead is formed to be at most 1/10 of a length of the electrode lead.

2. The battery cell of claim 1, wherein the current breaking portion is formed of a material which is melted in a range of 150° C. to 185° C.

3. The battery cell of claim 2, wherein the current breaking portion is formed of a material having an electrical resistivity of 0.2 μΩ·m or less.

4. The battery cell of claim 2, wherein the current breaking portion is formed of a material having a thermal conductivity of 40 W/m K or more.

5. The battery cell of claim 2, wherein the current breaking portion is formed of a material having a tensile strength of 100 kgf/cm² or more.

6. The battery cell of claim 2, wherein the current breaking portion is formed of an alloy material including tin.

7. The battery cell of claim 6, wherein the current breaking portion is formed of any one material selected from the group consisting of tin/lead, tin/lead/silver, tin/indium/silver, and tin/lead/indium.

8. The battery cell of claim 7, wherein the tin/lead is an alloy comprising 60 to 65 wt % of tin and 35 to 40 wt % of lead, the tin/lead/silver is an alloy in which 1 to 2 wt % of silver is added to the tin/lead, the tin/indium/silver is an alloy comprising 75 to 80 wt % of tin, 18 to 22 wt % of indium, and 1 to 5 wt % of silver, and the tin/lead/indium is an alloy comprising 68 to 72 wt % of tin, 15 to 20 wt % of lead, and 10 to 15 wt % of indium.

9. The battery cell of claim 7, wherein the current breaking portion is formed of any one material selected from the group consisting of Sn63/Pb37, Sn62.5/Pb36.1/Ag1.4, Sn60/Pb40, Sn77.2/In20/Ag2.8, and Sn70/Pb18/In12.

10. The battery cell of claim 1, wherein the electrode lead comprises a first lead disposed between the current breaking portion and the electrode tab and a second lead disposed on the opposite side of the first lead.

11. The battery cell of claim 1, wherein the electrode lead is a negative electrode lead connected to the negative electrode plate.

12. The battery cell of claim 1, wherein the electrode lead is formed of a copper material.

13. A battery cell, comprising:
an electrode assembly in which at least one positive electrode plate and at least one negative electrode plate are stacked with each other;
a case accommodating the electrode assembly therein;
a plurality of electrode tabs respectively extending from the positive electrode plate and the negative electrode plate;
an electrode lead having one end bonded to the electrode tab and the other end extending to the outside of the case; and
a current breaking portion disposed inside the electrode lead to break a flow of overcurrent,
wherein the current breaking portion is formed of a material which is melted in a range of 150° C. to 185° C., has an electrical resistivity of 0.2 μΩ·m or less, and has a tensile strength of 100 kgf/cm² or more.

14. A battery apparatus, comprising:
a plurality of battery cells having a case in which an electrode assembly is accommodated, and an electrode lead extending from the electrode assembly and at least a portion of which is disposed outside the case; and
a bus bar coupled to the electrode lead,
wherein a current breaking portion to break a flow of overcurrent is disposed inside the electrode lead, and the current breaking portion is disposed to be spaced apart from the bus bar by a certain distance.

15. The battery apparatus of claim 14, wherein the current breaking portion is formed of a material which is melted in a range of 150° C. to 185° C.
